(19) United States
(12) Patent Application Publication
(10) Pub. No.: US 2004/0170912 A1
(43) Pub. Date: Sep. 2, 2004

(54) Color and process color dry toners and compatible toning systems for use in high-speed electrographic digital printing

(76) Inventor: Michael W. Brennan, Hidden Hills, CA (US)

Correspondence Address: PERKINS COIE LLP, POST OFFICE BOX 1208, SEATTLE, WA, 98111-1208, US

(21) Appl. No.: 10/729,390

(22) Filed: Dec. 5, 2003

Related U.S. Application Data
(60) Provisional application No. 60/431,527, filed on Dec. 6, 2002.

(51) Int. Cl. G03G 9/087; G03G 15/08

(52) U.S. Cl. 430/108.6; 430/108.8; 430/109.3; 399/252; 399/279

(57) ABSTRACT

A non-magnetic toning system for inclusion in a magnetic toning system is disclosed. Further the invention is directed to the process of color imaging, which can be divided into two main categories: (1) line, highlight, or imaging, wherein a permanent toned image of a color, including black, is produced using toner particles of a single color; and (2) process, or “near photographic” color imaging, wherein a permanent toned image is produced by selectively blending or mixing toner particles of two or more primary colors. The invention is directed to an interchangeable Non-Magnetic Toning System (“NMTS”) using specific toners in compatible printing machines. The NMTS using specific toners will be useful in printing machines currently on the market using magnetic toning systems. More particularly, specific toners of this invention relate to dry toners, which may advantageously be used in color imaging, black text, and MCRI printing, and the compatible toning system required for transferring the dry toners to a latent electrostatic image created within an electrophotographic or electrographic printing system.

### PRIORITY CLAIM

This application claims priority to U.S. Provisional Application Serial No. 60/431,527 filed on Dec. 6, 2002, and incorporated herein by reference.

### FIELD OF THE INVENTION

The present invention relates to dry toners and a compatible toner application system suitable for use in specialized high-speed imaging applications.

### BACKGROUND OF THE INVENTION

Current printing technology uses multiple compositions and/or techniques to create printable images on numerous media. Dry toners are one such category of compositions used. Dry toners are powder substances that are used in electrophotographic or electrographic imaging systems to create visible images on paper, film, vellum, plastics, or other substrates. Such toners are composed of at least one resin that may be mixed with a colorant, and other additives such as flow promoters and charge control additives. The composition of the toners may also include mixtures or copolymers of resins in varying amounts selected to provide desired characteristics in the visible image produced (see, Brennan, et al, U.S. Pat. Nos. 5,333,042 and 5,834,150).

The initial step in Electrography is the process of creating images electrically by the direct deposition of charges on an insulating or dielectric layer. The latent electrostatic images to be toned in the electrographic process, either positive or negative charges that replicate the image, are created by the silent electric discharge method of latent image charge generation, which has been commercially successful and called electrography. This technology has been referred to as ion deposition printing, charge deposition printing, and Electron Beam Imaging (“EBI”). Fotland et al U.S. Pat. Nos. 4,155,093 and Carrish U.S. Pat. No. 4,160,257 disclose this method of forming electrostatic latent images employing a gated charge source spaced at a distance from a dielectric receptor surface. Here, a charge is formed using a low energy corona spark, or silent electric discharge, and the flow of those charges are directed to a dielectric recording surface, typically either an imaging drum or continuous imaging belt. Image generations of these types are described in U.S. Pat. Nos. 4,155,093; 4,160,257; 4,819,013; 4,992,807; 5,159,358; 5,278,588. These references, as well as all references cited herein, are incorporated as if fully disclosed in this application.

Finally, the toned image on the media is permanently fixed, or printed on the media, by pressure and heat, radiant energy, or vapor fusing. Alternatively, the toned image on the media may be over-coated in a separate process by an application of a clear varnish, shellac, or other appropriate translucent coatings.

Similarly, the initial step in an electrophotographic imaging process is image creation and toner development. In a typical electrophotographic imaging process, e.g., laser or Xerographic printing, a laser is used to create a latent electrostatic image on a photoreceptive drum, belt, or other device having a smooth surface capable of retaining a photoconductive layer. The smooth surface of the photoreceptor is first given a blanket of uniform electrostatic charge, by means of a high voltage corona device, a lower voltage charging roller or shoe, or other charging element. A laser beam is then swept across the photoreceptor to discharge the potential at selected areas of the surface. The selective discharge is accomplished by modulating the light intensity of the beam as it sweeps, or by selectively activating and deactivating the laser by means of appropriate driver electronics. A latent electrostatic image of the desired shape, style, and appearance is thereby formed on the surface.

In a variation of the electrophotographic process, a linear array of light-emitting diodes (LEDs), activated by appropriate switching means, may be used to create the image. Once a latent, electrostatic image is created by any of the aforementioned charging and exposure means, a corresponding visible image is developed, typically by applying an electrostatically charged toner to the photoconductive layer using a magnetic brush, cascade, powder cloud, or other developer system commonly known in the art. The electrophotographic process is well known in the art as exemplified by Mugrauer, U.S. Pat. No. 4,311,723 and Brennan, et al., U.S. U.S. Pat No. 5,333,042, which, along with all references cited, are fully incorporated as if fully set out herein.

In contrast to electrophotographic printing systems, electrographic printers do not use light to create a latent electrostatic image. The electrographic printers commonly employ a nib-type or electron beam printhead to form an electrostatic image of the desired shape and appearance of the image on the dielectric-imaging surface, by selectively depositing an electrostatic charge. Once the image is formed, toner development follows. See for example, Brennan, et al., U.S. Pat. No. 6,386,684.

As mentioned above, after the image toning or development step, electrophotographic and electrographic systems undertake to permanently fix the image to a substrate, paper, or media. In conventional laser printers, for example, fixation of the toner to the substrate is accomplished by exposure to heat and pressure—a process known as hot roll fixing. In hot roll fixing, the media having either electrostatic or pressure attached toner is typically passed between two rollers. One roller is an internally heated roller, and the other is a conforming pressure roller. The rollers press the toner against the media, while the heat transferred to the substrate and the toner causes the toner to melt and become adhered to the substrate or media. At extremely high-speeds, and to prevent images from being offset on the heat roller and creating multiple ghost images on subsequently printed substrates, a condition known as “hot offset,” a thin layer of silicone oil is applied to the surface of the heat roller. The silicone oil acts as a release agent, preventing the toner from adhering to the roller.

Alternatively, radiant heat may be employed to fix the toner to the substrate in a process known as radiant heat fixing or flash fixing. In radiant heat fixing, high intensity lamps are typically used as the heat source. Because the substrate surface does not come into contact with any roller or conductive heat element, radiant heat fixing avoids image offset problems. Using radiant heat fixing, it is also possible to achieve duplexing or the fixing of the toner to both sides of the media in a single fixing cycle.

A disadvantage common to heat and pressure, and thermal/radiant fixing methods, has arisen in certain specialized applications, particularly in security document imaging, color imaging, and magnetic ink character recognition (MICR) printing. In those applications, toner flow is often insufficient to “wick” the toner into the fibrous mat of the media to the extent that it is desirably impossible to remove the toner without destroying the media. Such permanency of adhesion is advantageous in security documents, the coalescing of color toners and MICR applications.

A third type of toner fixing system employs solvent vapors to fix toners to a media, a process known as vapor fixing. In vapor fixing, a solvent chemical vapor, i.e., a fixing agent, is vaporized and placed in contact with the electrostatically or pressure attached toner, thereby solvating the toner, and causing it to be fixed to the media. The term “solvating” or “solvates” as used herein refers to the fixing agent's interaction with the toner whereby the toner is partially or completely dissolved in or solubilized by the fixing agent, and “solvatable” refers to the capability of being solvated. See Brennan, et al., U.S. Pat No. 5,333,042.

In vapor fixing, the media surface having the toner does not come into contact with any hot roller, pressure roller, or conductive heat element. Thus, vapor fixing is not subject to hot and cold offset. Moreover, vapor fixing allows for single cycle duplexing because of the absence of hot rollers or conductive heat elements in contact with the toned image portions of the substrate.

Presently employed vapor fixing techniques generally use vapors of an environmentally acceptable halogenated hydrocarbon as the solvent, commonly known as HCFC141b, and sold under the name (GENETRON 2000) by Allied-Signal, Inc., Morristown, N.J. See Brennan, et al., U.S. Pat No. 5,333,042. Vapor fixing methods have also been developed that are compatible with EBI and the toners that are disclosed herein are fused on a wide variety of media and printable stocks at extremely high speeds. Vapor fixing is known to fix toner having carbon black colorant to substrates at speeds of more than 500 feet per minute, and since it does not require heat, vapor fixing has proven both energy efficient and cost effective for large-scale printing operations.

Toners and toning systems can generally be divided into two main categories:

(1) Magnetic: The magnetic toner particles that are transferred to the latent electrostatic image are controlled by magnetic fields, and the toner's inherent magnetic quality, as they flow through the magnetic toner system. The magnetic toner's composition is usually a resin combined with a ferrous oxide (FeO₂) or other magnetic components, carbon black, and wax. Two types of magnetic toning systems are prevalent. First, a dual component toner system is one in which the toner particles are attached to a much larger “magnetic carrier bead,” charged by the surface interaction between the particles, and magnetically guided through the toning system. The charged toner particles are electrostatically transferred to the imaging substrate from a magnetically formed toner brush formed on a transfer roller and then the larger magnetic carrier particles are recirculated and recoated with toner particles. A second type of magnetic toning system is a single component magnetic toner system. Here, the toner particles are magnetic and absent the magnetic carrier beads. The flow of toner particles through the toner system is controlled by magnetic fields and the transfer of those toner particles to the imaging substrate is by electrostatic attraction. The significant limitations related to magnetic toners are caused by the inherent magnetic (FeO₂) composition of the toner. These limitations are secondary to characteristics of the composition which include, but are not limited to; opaqueness, which precludes color toners; weight and large imaging (particle) sizes, which impedes the electrostatic transfer to the dielectric imaging surface and minimizes imaging speed; and inherent abrasiveness.

(2) Nonmagnetic. The Second type of toning system is the nonmagnetic toning system (“NMTS”). The NMTS's purpose is to charge a single component nonmagnetic toner, comprising certain polymers, colorants, and charge control additives, control the flow of the toner through the system, and transfer the charged toner particles to the latent electrostatic image that is formed on a dielectric recording surface, either an imaging cylinder or belt.

As will be described below, the toners and methods of the preferred embodiments of this invention provide a means for achieving high speed color imaging without the disadvantages associated with presently available color toner formulations. It is anticipated that this invention also advantageously provides for the use of multiple intermediate transfer methods, pressure or electrostatic, and accommodates a multiple of final fixing processes; pressure and heat, radiant energy, and solvent vapor fixing to achieve results which are not achievable by present fixing methods.

### SUMMARY OF THE INVENTION

Certain embodiments of the present invention are directed to the process of color imaging, which can be divided into two main categories: (1) line, highlight, or imaging, wherein a permanent toned image of a color, including black, is produced using toner particles of a single color; and (2) process, or “near photographic” color imaging, wherein a permanent toned image is produced by selectively blending or mixing toner particles of two or more primary colors. If so desired, such toners may be used in an interchangeable Non-Magnetic Toning System (“NMTS”) using specific toners in compatible printing machines. The NMTS is interchangeable in that is can replace the magnetic toning system of compatible printing systems. One example of a compatible printing system is the Delphax printing system depicted in the Figures. Thus, NMTSs using specific toners may be useful in printing machines currently on the market using magnetic toning systems.

More particularly, specific embodiments provide dry toners, which may be used in color imaging, black text, and MCRI printing, and the compatible toning system required for transferring the dry toners to a latent electrostatic image created within an electrophotographic or electrographic printing system.

Further, the toners of embodiments of this invention are nonmagnetic particles and are tribocharged as they flow through the NMTS. The charging of such nonmagnetic toner particles may be effected by the nonmagnetic toner system and the intrinsic characteristics of the nonmagnetic toner(s). This method of depositing a nonmagnetic toner on a latent electrostatic image may employ a single print engine per color employing an NMTS and is readily adaptable to the high-speed digital printing of variable images in color, for the digital printing of several colors, and in certain applications the system can be used to create an unlimited spectrum of'process colors, e.g., by the digital coalescing of nonmagnetic toners whose colorant additives produce toners of primary subtractive colors: cyan, yellow, magenta and black (“CYMK”). One embodiment of this invention has successfully imaged at rates of 550 linear 8½″×11″ pages per minute, with each page consisting of a different image, or the transfer of variable data.

Certain imaging processes described herein have four steps: 1) The creation of an electrostatic image, e.g., by electrophotography or electrography; 2) The transfer of dry toners to the electrostatic image creating a toned latent image; 3) The intermediate transfer of the toned image, e.g., by electrostatic attraction or pressure, to paper, film, vellum, plastics, or other printable substrates (“Media”); and 4) The permanent fixing, or fusing, of the toner to the media, e.g., by heat and pressure, by radiant fusing, or by vapor fusing.

In one aspect of the invention, the specific toners are toners for color process imaging. Known toners adapted for use in process color imaging, i.e., those functioning as true subtractive primaries, are composed of colorants embedded in mixtures of copolymers of resins. As used herein, the term “resin” is synonymous with the terms “toner resins,” “toner binders,” and “binders.” Toner particles are transferred, in this aspect of the invention, through the NMTS. The toner particles are charged as the particles flow through the NMTS, and the NMTS then transfers those charged toner particles to the latent electrostatic image (“charged image”) which has been created on the dielectric recording surface through the earlier electrographic process. After the toner particles are transferred to the charged image on the dielectric recording surface, the dielectric surface then acts as an intermediate carrier for the toned image to a point where the toned image is transferred to paper, film, vellum, plastics, or other printable media, e.g., by pressure or electrostatic attraction, and initially fixed to that media.

Process color imaging may also involve the selective blending or mixing of monochrome toners matched in hue, saturation (chroma), and brightness, to attain a permanent toned image of any desired color. Process color toners may function as true subtractive primaries in accordance with one of the standard color gamuts, such as the well-known Specification Web Offset Printing (“swop”) or the Pantone color standards. By selectively blending process color toners, cyan, yellow, magenta and black (“CYMK”), typically cyan (minus red), magenta (minus green), and yellow (minus blue), it is possible to produce images of any color, and generate multi color images having near-photographic quality.

In one aspect of the invention, novel process color toner formulations using primary resins, secondary resins and additives have improved handling and storage characteristics. These primary resins, which may be used alone or in combination with secondary resins and additives, include styrene-acrylic, styrene-methyl methacrylate, styrene-butyl methacrylate, styrene-ethylhexyl methacrylate, polystyrene, styrene-butadiene, and mixtures thereof. In another aspect of the invention, the process color toners of this invention include secondary resins, such as polyesters, and styrene-based, as well as non-styrene-based polyamide or polyester resin materials. The measured addition of one or more secondary toner resins to the primary resin prior to compounding of the process color toners of the invention allows for control over the smoothness, degree of gloss, and degree of adhesion of the fixed color image to the substrate. See Brennan, U.S. Pat. No. 5,834,150.

Many of the specific toners disclosed herein adhere to a wide variety of media by the application of a heat roller and a conforming pressure roller in the configuration that is further disclosed.

One useful embodiment of the NMTS invention is a toning system that is electrically and mechanically compatible with those magnetic toner systems, incorporated in certain electrographic printing systems, consisting of five subsystems:

1) Three internal rotating components: Transfer Roller, Donor Rollers, Mixer Blades and associated Drive Motors, and electronics: i) A Transfer Roller that is motor driven and conductive, comprising a conductive metal shaft coated with neoprene, or a similar material, which is in contact with the electrographic system's dielectric recording surface when imaging, and effects the transfer of the charged toner particles to the latent electrostatic image, ii) A Donor Roller that is motor driven and conductive, comprising a conductive metal shaft coated with a conductive fur coating, and effects the transfer of toner particles to the Transfer Roller, and iii) A motor driven Mixer Blade assembly that continually mixes the toner particles that are supplied and stored in bulk within the NMTS, and ratably and uniformly supplies those toner particles to the Donor Roller.

2) A Metering Blade assembly that consists of spring-loaded apparatus of two (2) white carbon steel metering or doctor blades. The Metering Blades are mounted at oblique angles to the Transfer Roller and provide a tribocharging interface for the toner particles at the Metering Blade's tip and regulates or meters the toner particle's height on the Transfer Roller.

3) An Actuating Assembly, solenoid-based, that engages the NMTS assembly with an electrographic printing system. More specifically, the system physically engages the NMTS's toner Transfer Roller with the electrographic printing system's dielectric imaging drum, or belt, during an imaging process and disengages the Transfer Roller when the system is not imaging.

4) Electronic and sensor components consist of i) a motion sensor subassembly, which detects the rotation and speeds of the NMTS's Transfer Roller and the electrographic printing system's dielectric imaging surface, ii) the quantity of a bulk toner stored within the NMTS, and iii) speed information for the NMTS's drive motor.

5) A clam shell enclosure that accommodates the i) Transfer and Donor Rollers and Mixer Blades, ii) Metering Blade assembly, iii) Actuating Assembly mountings, iv) intermediate storage for bulk toner, v) housing for the electromechanical parts, electronic components, wiring harness and connectors, and vi) a toner dispensing system.

### BRIEF DESCRIPTION OF THE DRAWINGS

FIG. 1 is an electrical representation of the generation of an electrostatic image on a dielectric recording surface, and the electrical biasing system employed within the nonmagnetic toner system.

FIG. 2 illustrates the mechanical components, triboelectric charging mechanical interfaces, toner flow of a nonmagnetic toner within the NMTS. Also, illustrated are the intermediate pressure toner image transfer, and the final fixing of the toner onto the media via a heat and pressure fixing apparatus.

FIG. 3 is a diagram of a Delphax EBI print engine employing a magnetic toner system.

FIG. 4 is a diagram of a Delphax print engine implementation with an NMTS installed.

FIG. 5 illustrated the NMTS and actuating apparatus that engages, and releases, the NMTS from certain electrographic print systems manufactured by Delphax Systems. Further illustrated is the motor assembly for the Donor and Transfer Rollers, and the motor assembly for the Mixer Blade Apparatus.

FIG. 6 illustrates the use of multiple electrographic print engines employing multiple NMTS's, of this invention, for printing a combination of one through four colors, either of which could be black text, a spot color, or the full gamut of process colors (CYMK).

### DETAILED DESCRIPTION OF INVENTION

Some embodiments provide specific toners having a low thermal melting characteristic, e.g., under 90° C., and that adhere to a wide variety of printable stocks at extremely high-speeds.

Resins, such as polyethylene terephthalate, propoxylated bisphenol-A fumarate, and other resins including styrene acrylics, have been selected for process color toners generally because they have excellent pigment (colorant) dispersion properties. Thus, they minimize interfacial boundaries between the colorant and the resin binder. Interfacial boundaries cause internal scattering of incident light with a toner layer, and thereby desaturate the resultant image color, reducing color purity.

One property of polyester and styrene acrylic resins that minimize interfacial boundaries is good pigment wetting during image fixing. Another property is low melt viscosity, i.e., high melt index. Polyester and styrene acrylic resins typically exhibit a low melt viscosity, which enables rapid flow under the application of heat. When subject to thermal fixing, this rapid flow characteristic allows the toner particles containing process color colorants to properly coalesce and form an essentially transparent layer of the toner of the appropriate hue, brightness, and chroma. This thorough mixing of the subtractive primary toner colorant particles facilitates intimate blending to minimize interfacial boundaries. In addition to minimizing interfacial boundaries, the low melt viscosity of these resins aids in the formation of an image of uniform surface smoothness and gloss, which avoids the problem of a surface light scattering, and further enhances the color's brilliance.

The constituent components of the preferred embodiment of the toner invention include: 1) A styrene acrylic toner resin (e.g., about 88% by weight), which is an environmentally safe polymeric binder for the colorants (pigments), can acquire, and retain, an electrostatic charge, and has the proper melt-flow characteristics for both cold pressure and heat fusing. 2) A polypropylene wax (e.g., about 8% by weight) incorporated for its extensible and excellent release properties for the initial cold pressure fusing process. 3) A charge control additive (e.g., about 1% by weight) that promotes rapid positive charging and charge retention. 4) Primary colorants that include carbon black and other organic pigments. In one embodiment, the carbon black component is a Lewis-base electron donor and as such aids in the creation of a positive electrostatic charge. Specific toners of the invention may also contain some post process additives. These additives may include titania, for example, titanium oxides or simply titanium. Further, silica may be used, for example, silicon dioxides. These post process additives may be added during the Henschel or final mixing process, and respectively promote toner flow and charge reception. The toner particle sizes by volume (Mᵥ) may be about 15-16 microns.

The specific toners provide for the intermediate pressure or electrostatic transfer of the toner from the imaging dielectric to the media and finally heat and pressure, radiant energy, or vapor fixing of the toner to the media.

In one embodiment, the use of a NMTS facilitates: 1) the uniform creation of a charge on each particle of toner, 2) effects the flow of the total volume of the toner through the NMTS that is required for imaging and 3) transfers the charged toner particles to the latent electrostatic image on the dielectric recording surface. In a particular NMTS implementation, the toner particles of 15-16 micron sizes are triboelectrically charged positively, and then electrostatically transferred to the negatively charged electrostatic latent image on the dielectric recording surface.

The flow of toner particles through the NMTS may be controlled as the charge on the toner particle is created and until transferred to the latent electrostatic image on the dielectric surface. The NMTS can contain two (2) direct current biasing systems that electrostatically attract the toner particles onto the two dissimilar rollers within the NMTS and propel the particles through NMTS by the biasing system's electromotive force.

In one exemplary system, the electrostatic charge on the toner particle is generated by a combination of triboelectric charging events wherein dissimilar materials, the toner particles and the components of the NMTS, are placed into contact and then separated. This creates a charge separation wherein a plurality of electrons are pulled away from the toner particles, and in the current embodiment, creating a more positive charge on the toner particle which is then ultimately attracted to the negative electrostatic charged representation of the image to be toned on the dielectric recording surface. The creation of the charge on the toner particle can be enhanced by the addition of charge control agents within the toner particle, which increases the rate that the charge can be built up on a toner particle, and helps maintain the uniformity of that charge.

In one embodiment, the electrographic methodology of electron-beam imaging EBI, formerly known as ionographic, or ion-deposition imaging, the image is created by an electron beam controlled by appropriate driver electronics. Electrons are deposited onto the insulating or dielectric surface of a rotating drum, or a continuous belt bearing a dielectric coating, such as alumina, for example, aluminum dioxides, thereby forming a latent electrostatic image. After the latent image is formed, the image is toned or developed in a manner similar to that performed in electrographic and electrophotographic printing systems. However, another embodiment employing a single component nonmagnetic toner and compatible NMTS, provides for the creation of toned images at high-speed and in color, process color, MICR, and black text, on a wide variety of printable stocks. Other embodiments described herein provide for the intermediate transfer of the toned image from the electrostatic surface of the drum or belt to the media by either cold pressure, or electrostatic attraction. Electrographic processes are well known in the art. See, for example, Fotland, et al., U.S. Pat. No. 4,267,556, the entire disclosures of which are incorporate herein by reference.

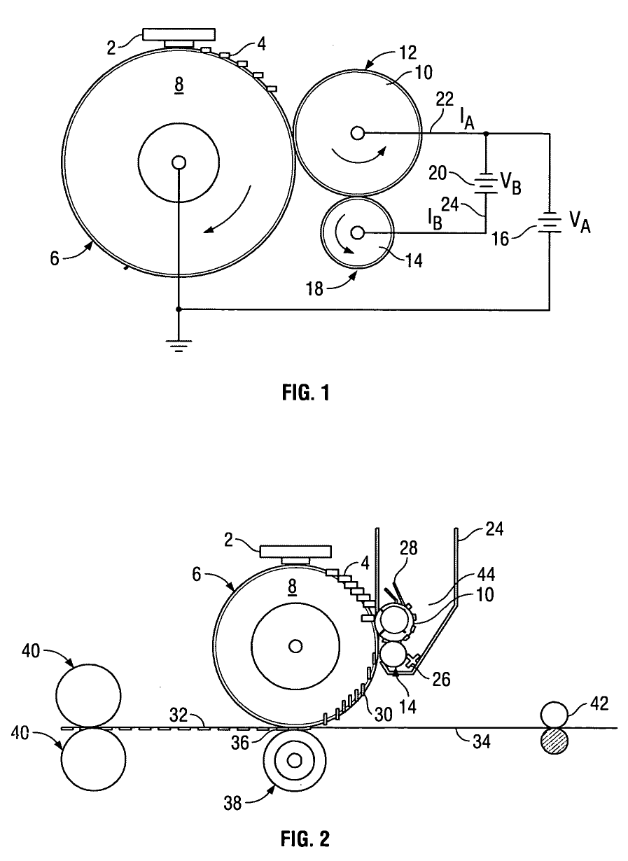

FIG. 1 illustrates one suitable NMTS. Within the NMTS, the biasing systems facilitate moving the nonmagnetic toners through the system. The process is initiated when the EBI Print Head 2 deposits a negatively charged Latent Electrostatic Image 4 of the image to be toned on the Dielectric Imaging Surface 6 of the Imaging Drum 8. The Imaging Drum 8 may consist of a Dielectric Imaging Surface 6 with a treated aluminum oxide coating formed on the surface of a solid aluminum core, with the core electrically grounded or, alternatively, any dielectric surface that will retain a charge with an electrically grounded opposing side, including a rotating belt configuration. The Toner Transfer Roller 10, with a Neoprene Surface 12 or similar materials that are of a triboelectric series more negative than the Toner Donor Roller 14, may be formed over an aluminum metal or other type of conducting shaft and is maintained at a negative potential V_{A} 16, to the core of the Imaging Drum 8, creating a capacitive interface between the Imaging Drum 8, Dielectric Imaging Surface 6 and the Toner Transfer Roller 10. The Toner Donor Roller 14 consists of a conductive Fur-Surface 18 over an aluminum, metal or other type of conducting shaft, is maintained at a positive potential V_{B} 20, with respect to the core of the Toner Transfer Roller 10 and is triboelectrically series positive with respect to the Toner Transfer Roller's 14 Fur-Surface 18. Experiments have proven that V_{A} and V_{B} can remain constant over a wide range of printing speeds and effect excellent transfer of toners to the Imaging Drum. Further, current flow I_{A} 22 also remains constant over a wide range of printing speeds, and current I_{B} 24 is inversely proportional to the amount of the toner available between the interface, or nip, of the Toner Transfer Roller 10 and the Toner Donor Roller's Fur-Surface 18 and may be used as an indicator for a low amount of the toner in the system.

Referring to FIGS. 1 and 2, which illustrate mechanical components of one embodiment, the NMTS's mechanical infrastructure provides for the triboelectric charging of the non-magnetic toner, which is composed of particles, and the toning of the electrostatic latent image that is to be printed. Initially the Nonmagnetic Toner 44 is dispensed into a Nonconductive Enclosure 24 and agitated by a Mixing Blade Assembly 26 that introduces the toner, in a controlled amount, to the fur-covered surface of the Toner Donor Roller 14. Toner Donor Roller 14 mechanically induces a positive charge on the Nonmagnetic Toner 22 by the triboelectric charging action created by the friction between the two triboelectric series dissimilar materials, the Toner Donor Roller's 14 Fur-Surface 18 and the Nonmagnetic Toner 44. The positive charge Nonmagnetic Toner 44 are next attracted to the Toner Transfer Roller's 10 conductive neoprene surface 12 by the biasing action of V_{B} which holds the surface of the Toner Transfer Roller 10 more negative than the surface of the Toner Donor Roller 14 and then charged further positive by the triboelectric action created by the friction between the Nonmagnetic Toner 44 and the Metering Blades 28. The Metering Blades 28 may be of a white carbon steel or other appropriate metal.

A Latent Electrostatic Image 4 of what is to be printed is created by the discharge of electrons from the EBI Pint Head 2. The positive charged Nonmagnetic Toner 44 from the Toner Transfer Roller 10 are attracted and transferred to the negative charge of the Latent Electrostatic Image 4 and a Toned Image 30 is formed while the rotating Toner Transfer Roller 10 is in contact with the Dielectric Imaging Surface 6 of the Imaging Drum 8. Areas of the Imaging Drum's 8 Dielectric Imaging Surface 6 that did not receive a Latent Electrostatic Image 4 are at a more positive potential V_{A} 16 than the surface 12 of the Toner Transfer Roller 10 and the excess positive charged Nonmagnetic Toner 44 is held, or retained, on the surface 12 of the Transfer Roller 10 which is held at a more negative potential V_{B} 20 than the Imaging Drum 8 by the biasing action of V_{B} 20.

The Toned Image 30 is then pressure transferred and initially fixed as a Printed Image 32 to the surface of the Paper or Other Media 34 that is to receive the printed image at the interface or Pressure Transfer Nip 36 between the electrographic system's Imaging Drum 8 and Pressure Transfer Roller 38 by a toner pressure transfer process, called transfixing. The final fixing of the Printed Image 32 to the media may be achieved by applying a combination of Heat and Pressure Fixing 40 to the Paper or Other Media 34, or alternatively radiant energy, a vapor bath, or a translucent over-coating. A representative paper path and appropriate Paper Guides 42 are illustrated, but alternate paper paths have been implemented including systems with parallel Transfer and Donor Rollers.

Styrene acrylic and polyester resins are the preferred toner resins in one aspect of this invention because process color toner resins preferably are clear and colorless, or “water-white.” Many other resins tend to be cloudy, translucent, or semi-opaque when viewed in the pure state, or have a yellow cast. All of these latter properties are undesirable for a process color toner resin because they detract from the purity of the color.

### EXAMPLE I

### Use in a Compatible Printing System

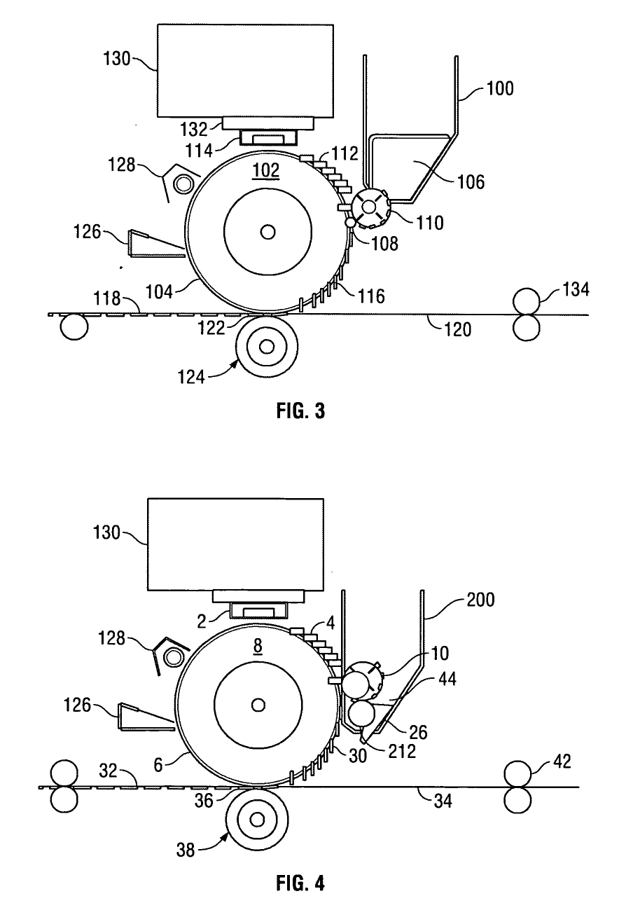

Referring to FIG. 3, this example depicts an electrographic printing system using EBI manufactured by Delphax Systems (Mississauga, Canada). This printing system employs a Magnetic Toner System 100, which is physically attached to the print engine and mounted adjacently to the Imaging Drum 102 and not in contact with Imaging Drum's Dielectric Recording Surface 104. In this process of transferring single component Magnetic Toners 106, well understood in the art, a brush of charged magnetic toners, Toner Brush 108, are formed on the surface of the Toner Application Roller 110 and held in place by the action of a magnetic sleeve rotating around an array of magnetic poles. The toner particles are transferred to the Electrostatic Image 112 that was formed on the Dielectric Recording Surface 104 of the Imaging Drum 102 by the electron beams that originate within the EBI Print Head 114. The Toned Image 116 is then transferred as a Printed Image 118 to Paper or other Media 120 at the Pressure Transfer Nip 122 that is formed by the pressure between the Pressure Transfer Roller 124 against the Imaging Drum 102. In many applications the magnetic toner is further fixed to the paper or other media by a secondary fusing process consisting of an application of radiant energy which melts the toner and enables the “liquefied” toner to adhere more firmly to the paper. Excess toner particles not transferred as the Printed Image 118 are removed from the Imaging Drum's 102 Dielectric Recording Surface 104 by the action of a Cleaning Blade 126 and finally all possible electrostatic charges are removed from the Imaging Drum's 102 Dielectric Recording Surface 104 by the action of the Erase Rod 128. Among other components of the magnetic printing system implemented EBI print engine are the electronic components, which are enclosed in an Electronic Assembly 130, a Print Head Assembly 132, and appropriate Paper Guides 134.

Referring to FIG. 4, the EBI Nonmagnetic Printing System depicted is one particular implementation of this invention, and incorporates the Nonmagnetic Toner System (NMTS) 200 that is directly interchangeable, both electrically and mechanically, with Magnetic Toner Systems incorporated in certain electrographic print systems; a Delphax non-magnetic printing system is used in this description. This interchangeability or “plug-compatibility” enables certain EBI Magnetic Printing Systems to print with nonmagnetic toners, disclosed herein, in any single color and transforms those EBI Magnetic Printing Systems into an EBI Nonmagnetic Printing System.

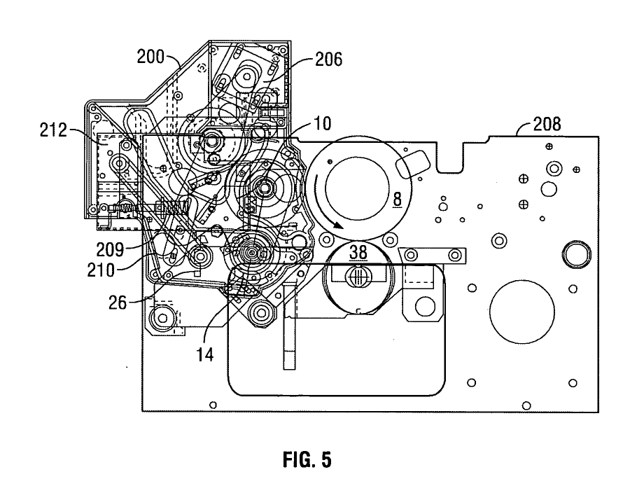

One mechanical difference between the NMTS 200 and the current Magnetic Toner System is that the Toner Transfer Roller 10 of the NMTS 200 is in physical contact with the Dielectric Imaging Surface 6 of the Imaging Drum 8 when imaging, or printing, and retracted when the EBI printing system is either stopped or not printing. Contrastingly, the Brush 108 (FIG. 3) of Magnetic Toner 106 (FIG. 3) that forms on the Toner Application Roller 110 (FIG. 3) is always in contact with the Imaging Drum 102 (FIG. 3). Here, the actuating mechanism, which effects and breaks the contact between the Dielectric Imaging Surface 6 and the Toner Transfer Roller 10 may be a simple solenoid and spring assembly 204 (FIG. 5) that attaches to mounting hardware on certain electrographic printers.

Such mounting apparatus is illustrated in FIG. 5, and when actuated moves the Nonmagnetic Toner System 200 toward the print engine until the Toner Transfer Roller 10 is in contact with the Dielectric Imaging Surface 6. The significant imaging performance difference is effected by the ability to print with Nonmagnetic Toners 44 which allow color imaging as compared with magnetic toner's inability to effectively print colors. Additional advantages of printing with nonmagnetic toners include higher print rates as the charge to mass ratio is clearly advantageous, improved image perception as the particle sizes are significantly finer, and improved permanent fixing because the constituent components in nonmagnetic toners can be melted and fused by either pressure and heat, radiant energy or chemically into printable substrates.

Referring to FIG. 5, an EBI Nonmagnetic Printing System, in one embodiment of this invention, can be implemented by mounting a Nonmagnetic Toner System 200, on the EBI Transport & Imaging Assembly 208 of compatible printing machines and mechanically connecting the two by use of a Mounting Bracket 210 that mechanically conforms to mounting points on the EBI Transport & Imaging Assembly 208, and provides for the installation of a simple spring and solenoid assembly, for example, that engages the Nonmagnetic Toner System 200 with the Imaging Drum 102 while imaging and disengages the two subassemblies when the system is not imaging. Also depicted in FIG. 5 are the Transfer and Donor Roller Motor 206 and Mixing Blades Motor 212.

### EXAMPLE II

### Multiple Color Generation with Sequential EBI/NMTS Print Machines

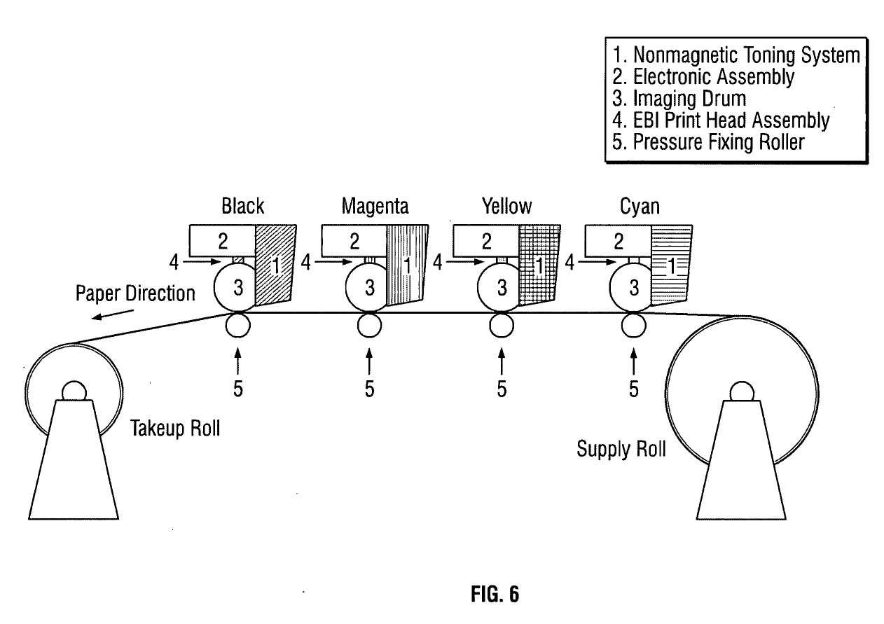

Referring to FIG. 6, a Nonmagnetic Printing System of another embodiment is depicted wherein there are one or more EBI/NMTS print engines mounted on an offset web press, or other paper guidance apparatus, with the EBI/NMTS print engines connected in a serial fashion and printing synchronously on a continuous web of paper or other printable media is capable of printing in multiple colors. A system comprising four (4) such EBI/NMTS print engines and using the full gamut of nonmagnetic color toners, and process color toners (CYMK), for example, can print in one or more colors, and full process color, or “near photographic color,” wherein a permanent toned image is produced by selectively blending or mixing nonmagnetic toner particles of two or more primary colors.

From the foregoing, it will be appreciated that specific embodiments of the invention have been described herein for purposes of illustration, but that various modifications may be made without deviating from the spirit and scope of the invention. Accordingly, the invention is not limited except as by the appended claims. The preceding Examples are intended only as examples and are not intended to limit the invention. It is understood that modifying the examples above does not depart from the spirit of the invention. It is further understood that the each example may be applied on its own or in combination with other examples.

1. Formulation of nonmagnetic toners for use in a non-magnetic toning system (NMTS) comprising:
a primary toner resin;
a polypropylene wax;
a charge control additive; and
a primary colorant.

2. The formulation of claim 1 further comprising a secondary resin.

3. The formulation of claim 1 wherein the primary toner resin is a styrene based resin.

4. The formulation of claim 3 wherein the styrene based resin is selected from the group consisting of styrene-acrylic, styrene-methyl methacrylate, styrene-butly methacrylate, styrene-ethylexyl methacrylate, polystyrene, styrene butadiene and mixtures thereof.

5. The formulation of claim 2 wherein the secondary resins are selected from the group consisting of styrene based polyesters, styrene-based resins of claim 3, non-styrene based polyamides and non-styrene based polyesters and mixtures thereof.

6. The formulation of claim 1 wherein the primary colorant comprises a plurality of primary colorants.

7. The formulation of claim 1 wherein the primary resins comprise at least about 88 percent by weight of the formulation.

8. The formulation of claim 1 wherein the polypropylene wax comprise at least about 8 percent by weight of the formulation.

9. The formulations of claim 1 wherein the charge control additive is at least about 1 percent by weight of the formulation.

10. The formulation of claim 1 further comprising a post process additive.

11. The formulation of claim 10 wherein the post process additive is a silica.

12. The formulations of claim 10 wherein the post process additive is a titania.

13. The formulation of claim 1 wherein the NMTS is compatible with an electrographic printing system.

14. The formulation of claim 1 wherein the NMTS is compatible with an electrophotographic printing system.

15. An NMTS interchangeable with a magnetic toning system in a printing system using the toner formulation of any one of claims 1-14 comprising:
at least three rotating components;
a metering blade assembly associated with at least one of the at least three rotating components;
an actuating assembly which engages one rotating component of the NMTS's at least three rotating components with the printing system; and
an enclosure housing the at least three rotating components and metering blade assembly.

16. The NMTS of claim 15 wherein the at least three rotating components comprise a transfer roller, a donor roller and a one or more mixer blades.

17. The NMTS of claim 15 wherein the transfer roller is motor driven.

18. The NMTS of claim 15 wherein the transfer roller is comprised of a conductive metal shaft.

19. The NMTS of claim 18 wherein the metal shaft conducts electricity.

20. The NMTS of claim 15 wherein the transfer roller includes a dielectric surface.

21. The NMTS of claim 20 wherein the dielectric surface comprises a photoreceptive material.

22. The NMTS of claim 21 wherein the dielectric surface is neoprene.

23. The NMTS of claim 16 wherein the donor roller is motor driven.

24. The NMTS of claim 16 wherein the donor roller conducts electricity.

25. The NMTS of claim 16 wherein the donor roller contains a fur coating.

26. The NMTS of claim 16 wherein the one or more mixer blades is motor driven.

27. The NMTS of claim 16 wherein the one or more mixer blades continuously mixes a supply of toner particles.

28. The one or more mixer blades of claim 27 wherein toner particles from the supply of toner particles are uniformly supplied to the donor roller.

29. The NMTS of claim 15 wherein the metering blade assembly comprises two spring-loaded blades.

30. The metering blade assembly of claim 29 wherein the spring-loaded blades are mounted at oblique angles to the transfer roller.

31. The metering blade assembly of claim 30 wherein each of the spring-loaded blades has a base and an edge.

32. The metering blade assembly of claim 31 wherein a tribocharging interface is created at the edge of at least one of the spring-loaded blades.

33. The NMTS of claim 15 wherein the actuating assembly includes as solenoid.

34. The NMTS of claim 15 wherein the one of the NMTS's at least three rotating components is engaged by the actuating assembly to a dielectric imaging surface of the printing system.

35. The NMTS of claim 34 wherein the one of the NMTS's at least three rotating components contacts the dielectric imaging surface during an imaging process.

36. The NMTS of claim 35 wherein the one of the NMTS's at least three rotating components is the transfer roller.

37. The NMTS of claim 34 wherein the dielectric imaging surface is part of a dielectric imaging drum.

38. The NMTS of claim 34 wherein the dielectric imaging surface is part of a dielectric imaging belt.

39. The NMTS of claim 15 wherein the printing system is electrographic.

40. The NMTS of claim 15 wherein printing system is electrophotographic.

41. The NMTS of claim 15 wherein at least one of the at least three rotating components separates from the dielectric imaging surface when the printing system is not imaging.

42. The NMTS of claim 41 wherein the at least one of the at least three rotating components a transfer roller.

43. The NMTS of claim 15 further comprising sensor components.

44. The sensor components of claim 43 comprising a motion sensor, a toner storage sensor and a speed sensor.

45. The NMTS of claim 15 wherein the enclosure accommodates a transfer roller, a donor roller, mixer blades, a metering blade assembly, a mounting system for an actuating assembly, an intermediate storage for a toner, a plurality of electronic components, a wiring harness and connectors, and a toner dispensing system.

46. A method of printing comprising:
providing a formulation of a non-magnetic toners;
placing the non-magnetic toner in an interchangeable NMTS;
replacing a magnetic toning system of a printing system with the NMTS in a compatible printing system; and
printing to a print medium.

47. The method of claim 46 wherein the formulations of non-magnetic toners are the toners of claim 1.

48. The method of claim 46 wherein the magnetic toning system in the compatible printing system is replaced with the NMTS of claim 15.
